(19) United States
(12) Patent Application Publication
(10) Pub. No.: US 2025/0131308 A1
(43) Pub. Date: Apr. 24, 2025

(54) QUANTUM COMPUTER

(71) Applicants: IQM FINLAND OY, Espoo (FI); UNIVERSIDAD DEL PAIS VASCO/ EUSKAL HERRIKO UNIBERTSITATEA, Leioa, Bizkaia (ES)

(72) Inventors: Hermanni HEIMONEN, Espoo (FI); Mario PONCE MARTÍNEZ, Munich (DE); Manuel GARCÍA PÉREZ ALGABA, Munich (DE); Vicente PINA CANELLES, Munich (DE); Inés DE VEGA, Munich (DE); Jorge CASANOVA MARCOS, Leiva, Bizkaia (ES)

(21) Appl. No.: 18/688,227

(22) PCT Filed: Sep. 14, 2021
(86) PCT No.: PCT/FI2021/050609

§ 371 Date: Feb. 29, 2024

(51) Int. Cl. G06N 10/40; G06N 10/20

(52) U.S. Cl. CPC G06N 10/40; G06N 10/20

(57) ABSTRACT

The invention relates to the field of quantum computing, more specifically to a novel arrangement of qubits in a quantum processing unit and a novel method for performing multi-qubit gate operations on the qubits. The system comprises multiple qubits coupled to a central resonator via tuneable couplers. The system is particularly suited to executing quantum algorithms featuring a centrally significant elements and may significantly reduce the number of quantum gate operations performed in such algorithms.

### TECHNICAL FIELD

The invention relates to the field of quantum computing, more specifically to a novel arrangement of qubits in a quantum processing unit and a novel method for performing multi-qubit gate operations on the qubits.

### BACKGROUND

Coupling large numbers of qubits in a quantum processing unit is technically challenging as the direct coupling of one qubit to many requires increasing capacitance or inductance, resulting in larger qubit sizes. Such constraints limits both the number of qubits that can be coupled and the number of qubits that can be formed on a single die or wafer. Furthermore, as larger numbers of qubits are coupled in a single system, frequency crowding prevents single qubits from being reliably individually addressed.

### SUMMARY

According to a first aspect of the invention, a system is provided. The system comprises a plurality of qubits, a plurality of tuneable couplers (102) and a resonator (103). Each of the plurality of qubits is coupled to the resonator via one of the plurality of tuneable couplers and each of the plurality of qubits is coupled to the resonator at a maximum of the EM wave in the resonator or within a region ±20% of the wavelength of the EM wave around a maximum of the EM wave in the resonator.

The system may further comprise control circuitry configured to prepare a first state in one of the qubits, transfer the first state into the resonator via the tuneable coupler, and perform a multi-qubit gate between the resonator and one or more of the other qubits by manipulating the tuneable couplers between the resonator and other qubits.

The system may further comprise a central qubit that is coupled to the resonator via a capacitor and control circuitry configured to prepare a first state in the central qubit, transfer the first state into the resonator via the capacitor coupling and perform a multi-qubit gate between the resonator and one or more of the plurality of qubits by manipulating the tuneable couples between the resonator and other qubits.

The qubits, tuneable couplers and resonator may form a first set in which the plurality of qubits is a first plurality of qubits, the plurality of tuneable couplers is a first plurality of tuneable couplers and the resonator is a first resonator, and the system may further comprise a second set comprising a second plurality of qubits, a second plurality of tuneable couplers and a second resonator (203). Each of the second plurality of qubits may be coupled to the second resonator via one of the second plurality of tuneable couplers and each of the second plurality of qubits may be coupled to the second resonator at maxima of the EM wave in the second resonator, and

the second resonator may be coupled to the first resonator.

The second resonator may be coupled to the first resonator by at least one coupling chain comprising a first tuneable coupler, a qubit and a second tuneable coupler.

The second resonator may be coupled to the first resonator by two coupling chains, each coupling chain comprising a first tuneable coupler, a qubit and a second tuneable coupler.

The system may further comprise one or more further sets of qubits, tuneable couplers and a resonator, in which the qubits are coupled to the resonator via the tuneable couplers at maxima of the EM wave in the resonator, and where the resonators of each of the multiple sets are coupled.

The resonators of each of the first set, second set and one or more further sets may be coupled in series.

Each of the plurality of qubits may be directly coupled to one or more of the other qubits in the plurality of qubits via a tuneable coupler.

Each of the plurality of qubits may be directly coupled to less than 6, 7, 8, 9 or 10 of the other qubits.

The system may be configured to simulate a spin system by encoding the spin state of each particle in separate qubits and performing multi-qubit gates on the qubits or qubits and resonator to simulate the interaction between particles.

According to a second aspect of the invention, a method is provided. The method comprises preparing a first state in a first qubit, transferring the first state into a resonator via a tuneable coupler and performing a multi-qubit gate between the resonator and one or more of further qubits by manipulating tuneable couplers between the resonator and one or more further qubits.

The one or more further qubits may comprise a plurality of further qubits logically arranged in a sequence of further qubits. Preparing the first state in the first qubit may comprises preparing a state in the first qubit and applying a Hadamard gate to the first qubit, and performing a multi-qubit gate may comprise performing the following steps in an iterative manner until there are no qubits remaining in the sequence of further qubits:
a) sequentially applying a controlled phase gate to the resonator and each qubit in the sequence of further qubits;
b) applying a Hadamard gate to the first further qubit in the sequence of further qubits;
c) swapping the state of the first further qubit in the sequence of further qubits with the resonator; and
d) removing the first further qubit from the sequence of further qubits.

### BRIEF DESCRIPTION OF THE DRAWINGS

FIG. 1 is a schematic representation of the arrangement of qubits in a first embodiment of the present invention.

FIG. 2 is a schematic representation of an embodiment of the invention including multiple coupled resonators.

FIG. 3 is a schematic representation of an embodiment of the invention in which qubits are directly connected via tuneable couplers.

FIG. 4 is a flow chart depicting a method of operating the system depicted in FIGS. 1 to 3.

FIG. 5 is a quantum circuit diagram depicting a method of performing a quantum Fourier transform on the system depicted in FIGS. 1 to 3.

### DETAILED DESCRIPTION

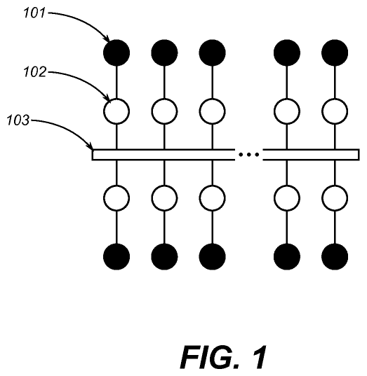

FIG. 1 shows a schematic representation of the arrangement of qubits in a first embodiment of the present invention. Individual qubits 101 (shown as black circles) are coupled via tuneable couplers 102 (shown as white circles) to a resonator 103. The qubits 101 may be transmon qubits, as described in detail in Koch et al., Charge-insensitive qubit design derived from the Cooper pair box, Phys. Rev. A 76, 042319 (doi:10.1103/PhysRevA.76.042319). The tuneable couplers 102 may also be transmons, or other coupling circuits whose frequency characteristics can be externally controlled so as to selectively couple each qubit 101 to the resonator 103, i.e. such that the coupling can be “on” or “off” as required.

The resonator 103 may be, for example, a superconducting coplanar waveguide resonator. Such a resonator is formed of a single conducting track with a pair of return conductors, one located on each side of the conducting track. Boundary conditions or either zero current or zero voltage are imposed at the ends of the conducting track, giving rise to a set of resonant frequencies that match the boundary conditions. The resonator mode frequency is close to the frequency of the qubits 101, while the default frequency of the tuneable couplers 102 is higher or lower than the frequency of the qubits 101. Preferably, the frequency difference between the qubits 101 and the resonator 103 is less than the absolute value of the anharmonicity of the qubit 101. For a transmon qubit, this is a negative value of approx. 2% of the transition frequency between the |0 [symbol] state and |1 [symbol] state.

The tuneable couplers 102 are located at positions along the resonator 103 that correspond to the positions of voltage maxima of the electromagnetic standing wave that arises within the resonator 103. Preferably the tuneable couplers 102 (and any direct qubit connections) to the resonator 103 are located within a region ±10% of the wavelength of the standing wave around each maximum. The tuneable couplers 102 (and any direct qubit connections) to the resonator 103 may, however, located within a region up to ±20% of the wavelength of the standing wave around each maximum. Thus, by scaling the length of the resonator 103, the number of maxima within the resonator can be increased, providing more locations at which qubits 101 can be coupled to the resonator 103 via tuneable couplers 102. Qubits 101 can be coupled to the resonator 103 (via the tuneable coupler 102) on each side of the resonator 103, as shown in FIG. 1. While FIG. 1 shows one qubit/tuneable coupler connected on each side of the resonator at a single location, up to 20 qubits can be connected to the resonator at each maximum.

In a first embodiment, in order to perform operations on the qubits, a first arbitrary qubit state is prepared in one of the qubits 101, which can be thought of as a central qubit (despite not necessarily being centrally located). The first state is transferred from the central qubit into the resonator 103 via the tuneable coupler 102 coupling the central qubit to the resonator 103. The first state may be prepared by applying a microwave pulse to the central qubit while the central qubit is decoupled from the resonator 103 by turning off the tuneable coupler 102. The tuneable coupler is turned off by tuning its resonant frequency to a specific frequency at which the interactions between the qubit and resonator cancel. Once the first state is prepared, the central qubit and tuneable coupler 102 are tuned to couple the central qubit to the resonator 103 for the specific length of time required to effectively transfer the first state from the central qubit to the resonator 103.

In a second embodiment, the central qubit (again, not necessarily centrally located) may be directly coupled to the resonator 103 by a capacitor, i.e. without an intermediate tuneable coupler. The first state is prepared in the central qubit and the central qubit is brought into resonance with the resonator 103 in order to transfer the prepare first state from the central qubit into the resonator 103. This transfer operation corresponds to a Rabi swap.

Once the first state has been transferred into the resonator 103, two qubit gate operations, such as a conditional phase gate, can be performed between the resonator and one or more of the other qubits by manipulating the tuneable couplers between the resonator and other qubits. In this way, the resonator is acting as an information storage component, rather than simply as an information bus as is commonly the case. Measurement can be performed by transferring the state of the resonator 103 back to the central qubit, or any qubit whose state can be measured. This arrangement therefore enables any of the qubits 101 to be coupled with any of the other qubits 101 via the resonator 103, and enables all-to-all coupling by swapping the state of each qubit 101 into the resonator sequentially. For applications and algorithms in which many-to-many couplings are required, this qubit arrangement significantly reduces the number of two qubit gate operations that must be performed compared to other qubit arrangements.

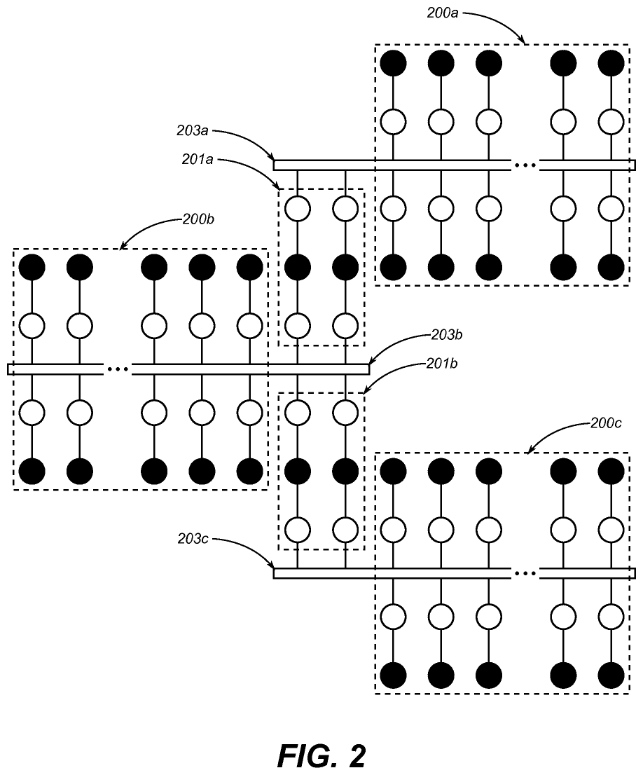

FIG. 1 shows a total of ten qubits 101 and ten tuneable couplers 102, but it is possible to couple at least as many as 48 qubits 101 and tuneable couplers 102 to a single resonator 103. This upper limit is governed by the diminishing quality factor of the resonator 103 as its length increases and the frequency separation of the resonator modes compared with the qubit linewidths. To further increase the number of qubits 101 that can be coupled, multiple groups on qubits, couplers and resonators 200a-c may be coupled via the resonators 203a-c as shown in FIG. 2. Preferably, each resonator 203a-c is coupled to another resonator 203a-c by two CQC couplings 201a, 201b, where each CQC coupling includes a first tuneable coupler (C) a qubit (Q) and a second tuneable coupler (C) connected in series. Each tuneable coupler in the CQC coupling is connected to a different one of the resonators 203a-c, linking the two resonators 203a-c. The two CQC couplings in each set 201, 201b are arranged in parallel between the resonators 103, 203. Each CQC coupling is connected to the resonators 203a-c at the maxima of the electromagnetic standing wave that forms within the resonator during operation. FIG. 2 shows three sets of qubits, couplers and resonators 200a-c, but further resonators may be coupled to any of the resonators 203a-c to form a chain of resonators or any other architecture.

The resonators 203a-c of sets 200a-c can alternatively be coupled by a single CQC coupling; however, a single CQC can be used to transfer a state from one resonator to the other if the target resonator is empty, i.e. in the ground state. To enable transfer of arbitrary states between both resonators, the two parallel paths provided by two CQC couplings as shown in FIG. 2 is needed. The limitations imposed by using a single CQC coupling between resonators may be desirable in certain application-specific implementations where the quantum algorithms run on the qubits do not require the transfer of arbitrary states between resonators, for example. Where two CQC couplings are provided between two resonators, the state from a first resonator is transferred into to the qubit of the first CQC coupling and the state from the second resonator is transferred into the qubit in in the second CQC coupling. The state from the qubit in the first CQC coupling is subsequently transferred into the second resonator, and the state from the second CQC coupling is transferred into the first resonator.

As a further alternative, the resonators may be connected by one CQC coupler and one direct coupler, i.e. a single tuneable coupler. The quantum state from a first resonator is transferred into the qubit in the CQC coupler, then an iSWAP gate operation is performed between the two resonators via the direct coupling to transfer the state from the second resonator into the first. Finally, the state held in the CQC qubit is transferred into the second resonator. Compared to a system with two CQC couplings joining the resonators, a single CQC coupling and a direct coupling results in a phase change in the state transferred via the direct coupling, whereas states transferred via the CQC couplings maintain the same phase. However, this may be acceptable or even desirable from some algorithms.

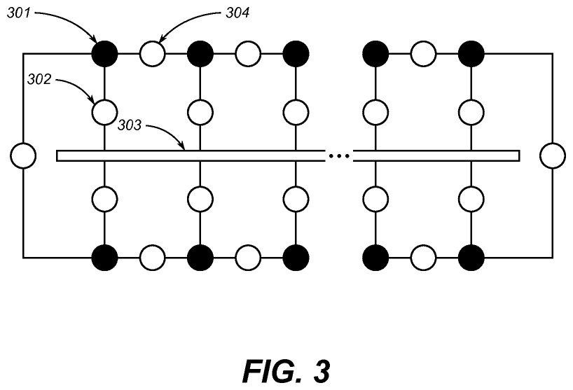

It is also possible for the qubits 101 to be directly coupled (i.e. not via the resonator 103) to other qubits 101. Such direct couplings may still include a tuneable coupler, as shown in FIG. 3 or, alternatively, the coupling between qubits may be via capacitive or inductive coupling, i.e. without a tuneable coupler. FIG. 3 shows a simple example of a system including a single resonator 303 where the qubits 301 are coupled to the resonator 303 via tuneable couples 302, but the qubits 301 are also directly coupled, i.e. not via the resonator 303, to adjacent qubits via tuneable couplers 304. Each qubit 101 may be directly coupled to as many as 6-10 other qubits as well as being coupled indirectly to other qubits 101 via the resonator 103. Furthermore, it will be appreciated that such direct qubit-qubit couplings may also be present in systems with multiple resonators 103, and such direct qubit-qubit couplings may exist between qubits connected to the same resonator and even different resonators.

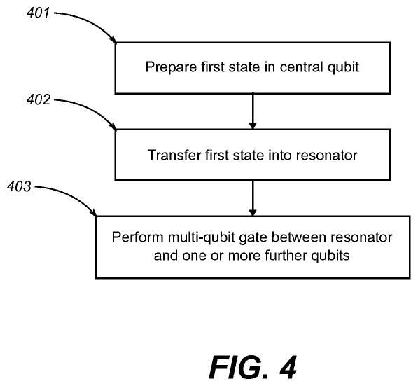

FIG. 4 is a flow chart showing a method for performing quantum operations on the qubits of the systems described above. At step 401 a first state is prepared in the central qubit (also referred to as the “first qubit”). The first state may be prepared by, for example, initializing the qubit in the |0 [symbol] state and applying one or more single-qubit quantum gates to move the qubit into the desired state.

At step 402, the first state is transferred from the central qubit into the resonator. Where the central qubit is connected via a tuneable coupler to the resonator, the state may be transferred to the resonator by applying a suitable stimulus to the tuneable coupler to turn on an exchange interaction between the central qubit and the resonator. This transfer corresponds to an iSWAP gate applied to the central qubit and the resonator. Where the central qubit is, in an alternative embodiment, coupled to the resonator via a capacitor, the state prepared in the central qubit may be transferred to the resonator by a Rabi swap.

At step 403, two qubit gate operations, such as a conditional phase gate, can be performed between the resonator and one or more of the other qubits by manipulating the tuneable couplers between the resonator and other qubits. In this way, the resonator is acting an information storage component, rather than simply as an information bus as is commonly the case. Measurement can be performed by swapping the state of the resonator back to the central qubit.

The same basic process can be applied to more complex systems such as that shown in FIG. 2 by performing repeated transfers between coupled resonators and qubits.

The system described above may advantageously be used for a number of practical applications, for example in the simulation of physical systems with a centrally influential element, such as spin systems, e.g. NV centres in diamond, where the spin (or other properties) of multiple bodies are interdependent. In such systems, the spin (or other property) of each body or particle is represented or encoded by one or more of the qubits and the interactions between each body or particle is represented by the connections and interactions between qubits.

As a further example, the system is particularly suitable for simulating a hyperpolarization protocol in which the qubit 0 represents the NV centre and the remaining N−1 qubits represent nuclei. Then the evolution of the system within one cycle is given by the evolution operator:

$$U = {e}^{- {itH}_{I}} = {e}^{- it ( {H}_{SQR} + {H}_{TQR} )}$$

where:

$${H}_{SQR} = {\sum }_{i = 1}^{N - 1} [ \frac{{A}_{i}^{x}}{2} \frac{{X}_{i}}{2} + \frac{{A}_{i}^{y}}{2} \frac{{Y}_{i}}{2} + ( \frac{{A}_{i}^{z}}{2} - {γ}_{c} {B}_{z} ) \frac{{Z}_{i}}{2} ] + \frac{Ω}{2} {σ}_{ϕ}^{0} \\ {H}_{TQR} = {\sum }_{i = 1}^{N - 1} [ \frac{{A}_{i}^{x}}{2} \frac{{X}_{i}}{2} {Z}_{0} + \frac{{A}_{i}^{y}}{2} \frac{{Y}_{i}}{2} {Z}_{0} + \frac{{A}_{i}^{z}}{2} \frac{{Z}_{i}}{2} {Z}_{0} ] + {\sum }_{k > j = 1}^{N - 1} \frac{{g}_{jk}}{4} ( {Z}_{j} {Z}_{k} - \frac{1}{2} {X}_{j} {X}_{k} - \frac{1}{2} {Y}_{j} {Y}_{k} )$$

In which X, Y and Z are the Pauli operators and σ_{ϕ}⁰=e^{iϕ}|1 [symbol] 0|+e^{iϕ}|0 [symbol] 1| operating on the central qubit. The remaining parameters are constants reflecting the physical system.

Since the gⱼₖ constants can usually be neglected, the resulting two qubit gates are operating only on the central qubit and a non-central qubit. A simulation algorithm can be generated by splitting the evolution operator up using a Trotter expansion. The algorithm requires only single qubit gates and two qubit gates that are applied on the central qubit and a non-central element, but no two-qubit gates applied on two non-central qubits. As a result, when the simulation is performed using the system of the present invention, it is possible to perform the algorithm without swapping any qubits, eliminating a significant number of steps required to simulate the physical system on quantum computing systems with other architectures.

The system may also be advantageously employed to perform quantum algorithms such as the quantum Fourier transform. In a system made up of a central qubit and N−1 further qubits coupled to a resonator, as described above, a quantum Fourier transform may be performed by sequentially swapping the state of each qubit into the resonator in order to perform the required two-qubit gates with other qubits.

First, the initial quantum states of each qubit are prepared in the required number of qubits, including the central qubit. A Hadamard gate is applied to the central qubit and the state of the central qubit is swapped into the resonator.

The other qubits 101 can be considered to be in a logical sequence, q₂ to q_{N}. A controlled phase gate CRₖ is applied sequentially to the resonators and each of the qubits 101 in the sequence q₂ to q_{N}, i.e. on the pairs [R, qₖ] where R is the resonator and qₖ for k=2 to k=N. The controlled phase gate CRₖ can be represented by the following matrix:

$${CR}_{k} = ( \begin{matrix}1 & 0 & 0 & 0 \\ 0 & 1 & 0 & 0 \\ 0 & 0 & 1 & 0 \\ 0 & 0 & 0 & {e}^{2 π i / {2}^{k}}\end{matrix} )$$

Next, a Hadamard gate is applied to q₂ and the resulting state of q₂ is swapped into the resonator.

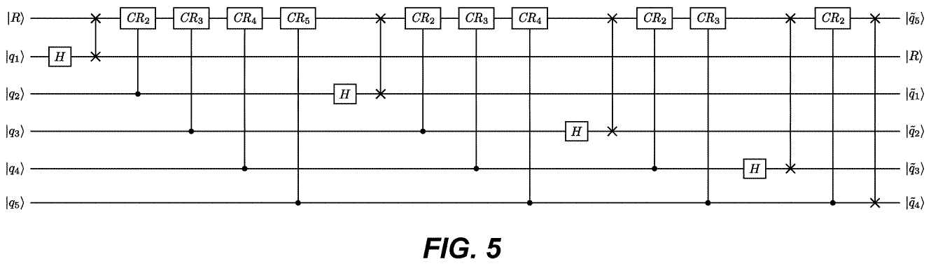

The process iterates with the indexes of each qubit shifted down by one, i.e. q₃ becomes q₂ or, more generally, qᵢ becomes qᵢ₋₁, and the previous q₂ is dropped from the sequence. The controlled phase gate is again applied sequentially to the resonators and each of the qubits in the sequence, beginning with q₂, i.e. to the pairs [R, qₖ] where R is the resonator and qₖ for k=2 to k=N−1. This process repeats until there are no qubits remaining in the sequence of further qubits. An exemplary quantum circuit diagram for a five-qubit system is shown in FIG. 5. It will be appreciated that the process can be expanded to an arbitrary number of qubits using the current system, although when multiple coupled resonators are used additional steps transferring the state between resonators will be required.

1. A system comprising:
a plurality of qubits;
a plurality of tuneable couplers; and
a resonator;
wherein each of the plurality of qubits is coupled to the resonator via one of the plurality of tuneable couplers and each of the plurality of qubits is coupled to the resonator at a maximum of the EM wave in the resonator or within a region ±20% of the wavelength of the EM wave around a maximum of the EM wave.

2. The system of claim 1, wherein the system further comprises control circuitry configured to:
prepare a first state in one of the qubits of the plurality of qubits;
transfer the first state into the resonator via the tuneable coupler;
perform a multi-qubit gate between the resonator and one or more qubit of the other qubits of the plurality of qubits by manipulating the tuneable couplers between the resonator and the one or more qubit of the other qubits of the plurality of qubits.

3. The system of claim 1, wherein the system further comprises a central qubit, which is coupled to the resonator via a capacitor, and control circuitry configured to:
prepare a first state in the central qubit;
transfer the first state into the resonator via the capacitor coupling; and
perform a multi-qubit gate between the resonator and one or more qubit of the plurality of qubits by manipulating the tuneable couplers between the resonator and other qubits of the plurality of qubits.

4. The system of claim 1, wherein the plurality of qubits is a first plurality of qubits, the plurality of tuneable couplers is a first plurality of tuneable couplers and the resonator is a first resonator, the first plurality of qubits, the first plurality of tuneable couplers and the first resonator forming a first set, and wherein:
the system further comprises a second set comprising a second plurality of qubits, a second plurality of tuneable couplers, and a second resonator;
each of the second plurality of qubits is coupled to the second resonator via one of the second plurality of tuneable couplers and each of the second plurality of qubits is coupled to the second resonator at maxima of the EM wave in the second resonator; and
the second resonator is coupled to the first resonator.

5. The system of claim 4 wherein the second resonator is coupled to the first resonator by at least one coupling chain comprising a first tuneable coupler, a qubit and a second tuneable coupler.

6. The system of claim 5, wherein the second resonator is coupled to the first resonator by two coupling chains, each coupling chain comprising a first tuneable coupler, a qubit and a second tuneable coupler.

7. The system of claim 4, wherein the system further comprises one or more further sets of qubits, tuneable couplers and a resonator, in which the qubits are coupled to the resonator via the tuneable couplers at maxima of the EM wave in the resonator, and wherein the resonators of each of the one or more further sets are coupled.

8. The system of claim 7, wherein the resonators of each of the first set, the second set and the one or more further sets are coupled in series.

9. The system of claim 1, wherein each qubit of the plurality of qubits is directly coupled to one or more of the other qubits in the plurality of qubits via a tuneable coupler.

10. The system of claim 9, wherein each of the plurality of qubits is directly coupled to less than 6, 7, 8, 9 or 10 of the other qubits.

11. The system of claim 1, wherein the system is configured to simulate a spin system by encoding a spin state of each particle in separate qubits and performing multi-qubit gates on the qubits or qubits and resonator to simulate the interaction between particles.

12. A method comprising:
preparing a first state in a first qubit;
transferring the first state into a resonator via a tuneable coupler;
performing a multi-qubit gate between the resonator and one or more further qubits by manipulating tuneable couplers between the resonator and the one or more further qubits.

13. The method of claim 12, wherein the one or more further qubits comprises a plurality of further qubits logically arranged in a sequence of further qubits;
wherein preparing the first state in the first qubit comprises preparing a state in the first qubit and applying a Hadamard gate to the first qubit; and
wherein performing a multi-qubit gate comprises performing the following steps in an iterative manner until there are no qubits remaining in the sequence of further qubits:
a) sequentially applying a controlled phase gate to the resonator and each qubit in the sequence of further qubits;
b) applying a Hadamard gate to a first further qubit in the sequence of further qubits;
c) swapping the state of the first further qubit in the sequence of further qubits with the resonator; and
d) removing the first further qubit from the sequence of further qubits.

14. The system of claim 1, wherein each qubit of the plurality of qubits is directly coupled to one or more of the other qubits in the plurality of qubits via a capacitive or inductive coupling.
